(19) United States
(12) Patent Application Publication
(10) Pub. No.: US 2013/0262326 A1
(43) Pub. Date: Oct. 3, 2013

(54) Intellectual Property Annuity/Maintenance Payment and Mistaken Abandonment Prevention Systems

(71) Applicant: THOMSON REUTERS (SCIENTIFIC) INC., Philadelphia, PA (US)

(72) Inventors: RENEE M DARRAGH, NORTHVILLE, MI (US); ADAM E. KENNEY, FREDERICK, MI (US); JOHN S. RYAN, LAKE ORION, MI (US); JOSEPH W. KAYE, JR., ROCHESTER HILLS, MI (US); JEFFREY A. KESEK, NEW BALTIMORE, MI (US); SHILPA KOMMIDI, TROY, MI (US); BRANDON E. VARILONE, FARMINGTON HILLS, MI (US)

(73) Assignee: THOMSON REUTERS (SCIENTIFIC) INC., Philadelphia, PA (US)

(21) Appl. No.: 13/724,297

(22) Filed: Dec. 21, 2012

Related U.S. Application Data
(63) Continuation-in-part of application No. 12/380,578, filed on Feb. 28, 2009.

(51) Int. Cl. G06Q 50/18; G06Q 10/00

(52) U.S. Cl. CPC G06Q 50/184; G06Q 10/00
USPC 705/310

(57) ABSTRACT

The invention relates to an automated computer implemented system and method that eliminates or at least reduces the possibility that rights associated with a piece of IP, such as a patent, trademark, patent application, and/or trademark application will be forfeited due to failure to pay a maintenance fee or annuity.

### CROSS-REFERENCE TO RELATED APPLICATIONS

This application is a continuation-in-part application and claims priority to Published U.S. Patent Application No. 2010/0223557 (application Ser. No. 12/380,578) filed Feb. 28, 2009 entitled “Method and System for Workflow Integration” bearing named inventors Adam Kenney, Phillip Henderson, and Jeffrey A. Thompson (hereinafter “IPM application”). This application is also related to U.S. patent application Ser. No. 13/724,128, filed concurrently herewith, entitled “Methods and Systems for Ad Hoc Intellectual Property Annuity/Maintenance Payments” naming Renee M. Darragh, Stephanie S. Emanuel, Joseph W. Kaye, Jr., Adam E. Kenney Jeffrey A. Kesek, and John S. Ryan as inventors (hereinafter “Ad Hoc application”) and referenced by Attorney Docket IPS(IP)_{—}008_US1. Both the IPM application and the Ad Hoc application are herein incorporated by reference as if set forth in their entirety.

### FIELD OF THE INVENTION

The invention relates to intellectual property (“IP”) docketing systems and methods. More particularly, the invention relates to systems and methods for ensuring certain pieces of IP do not mistakenly become abandoned. This patent application is filed concurrently with and incorporates by reference as if set forth in its entirety

### BACKGROUND

Many entities own IP. These entities include both individuals and corporations. Patents and trademarks are two types of IP for which an application may be submitted to a governmental agency, an examination conducted, and an enforceable right (e.g., an issued patent or trademark) granted to an entity. Service marks are another type of IP. Unless otherwise noted, as used herein, trademarks include both service marks and trademarks and trademark applications include both service mark applications and trademark applications.

Many large entities, such as publicly traded companies, have large IP portfolios requiring attention. Non-publically traded entities, such as law firms, manage IP portfolios on behalf of numerous clients, ranging from large publicly traded companies to individuals. In these situations, law firms provide the attention necessary to affect the goals of each client.

The attention required by patents and trademarks includes decisions as to whether to make annuity and/or maintenance payments. Sometimes the IP owner decides to let the IP lapse by, e.g., failing to make a payment due. This decision may be due to, e.g., the owner no longer needing the IP in a particular country, the cost/benefit analysis of retaining the IP, or some other reason. Sometimes, however, IP will lapse due to a mistake. In these situations, the IP owner may seek to be compensated not only for the money, time and effort to attempt to revive the IP that has lapsed but also the value of the IP itself if, e.g., the attempt to revive is unsuccessful. Even if the revival is successful, the IP owner may seek compensation if the piece of IP has diminished in value due to, e.g., “intervening rights” of a third party. The compensation the IP owner may seek from the entity (e.g., law firm) making a mistake in docketing or other error in communication or instruction is related to the value of the forfeited IP, at least in cases wherein the attempt to revive is unsuccessful. Thus, an entity mistakenly permitting the Coca Cola® trademark or Lipitor® patent in the United States to lapse will have more legal exposure than an entity mistakenly permitting a lesser know trademark or patent associated with a lesser know product to lapse.

Thomson Reuters' Thomson IP Manager® is used by many entities to ensure, among other things, that their IP is protected and preserved and that decisions as to whether to make annuity and/or maintenance payments are made in a timely fashion. Thomson IP Manager® is an enterprise-level intellectual asset management solution which gives an IP owner the power to enable collaboration between departments and the speed with which to make decisions to protect critical IP assets. The IPM application describes systems and methods for creating, defining, and performing IP related workflow processes.

While Thomson IP Manager® is both innovative and successful in the marketplace, neither it nor other known art, including the IPM application, the CPA system, or the CPi system, enables an entity to safeguard against the lapsing of a piece of IP.

### SUMMARY

We have recognized that entities responsible for tending to IP portfolios need to be able to designate a piece of IP as essential, eliminating the possibility of a docketing error or other error in instruction or communication that may result in the forfeiting of rights associated with the piece of IP. More specifically, we have recognized that automated computer implemented systems and methods that: (a) identify a time period; (b) generate a set of payment questions for which at least some of a set of payment answers are due and are associated with the time period, the set of payment decisions being associated with a set of intellectual property; (c) identify a subset of payment questions of the set of payment questions, the subset of payment questions being associated with a subset of intellectual property of the set of intellectual property and a subset of payment answers affirmatively indicating a desire to prevent the subset of intellectual property from lapsing; (d) generate an electronic signal indicative of the set of payment questions, the electronic signal being characterized in that the electronic signal prohibits entry of an instruction permitting the lapsing of a piece of intellectual property from the subset of intellectual property and being further characterized in that the electronic signal requests a second subset of payment answers associated with a second subset of payment questions, the second subset of payment questions being associated with a second subset of intellectual property, the subset of intellectual property being mutually exclusive from the second set of intellectual property; and (e) transmit the electronic signal. This eliminates, or at least reduces the possibility that rights associated with the piece of IP deemed essential will be forfeited.

Advantageously, the present invention eliminates, or at least reduces the possibility of an essential piece of IP being inadvertently abandoned.

Also advantageously, the present invention provides a running total of costs associated with preserving certain pieces of IP.

Additional advantages and/or features of the present invention will be set forth in part in the description. It is to be understood that both the foregoing general description and the following detailed description of the present invention are exemplary and explanatory and are intended to provide further explanation of the present invention as claimed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. In order to facilitate the understanding of the present invention, reference is made to the figures below in which like elements are referenced with like numerals. In order to avoid any potential confusion with the IPM application and the Ad Hoc application, the reference numerals in this application will begin with reference numeral 5100. To the extent any reference numbers conflict between this application and the IPM application and/or the Ad Hoc application, this application controls. Further, reference numerals with a value below 5100 refer to the IPM application and reference numerals having a value of 6100 or above refer to the Ad Hoc application.

FIG. 1 is a diagram of a VIP module residing on AMS 104 of FIG. 1 of the IPM application;

FIG. 2 is a more detailed diagram of the VIP module;

FIG. 3A is a flowchart representing the process by which a piece of IP is designated as essential;

FIG. 3B is a flowchart representing various aspects of the VIP process;

FIG. 4 is a flowchart representing the process by which the decisions of a client regarding a set of payment questions are processed; and

FIGS. 5a through 5t illustrate exemplary screen shots and user interface elements associated with FIG. 4.

### DETAILED DESCRIPTION OF THE EXEMPLARY EMBODIMENT(S)

This description will be made in the context of a hosted solution. However, those skilled in the art will appreciate that the details described herein may also be applied to any of the embodiments discussed within the IPM application including the five embodiments described in paragraphs 0011 through 0015.

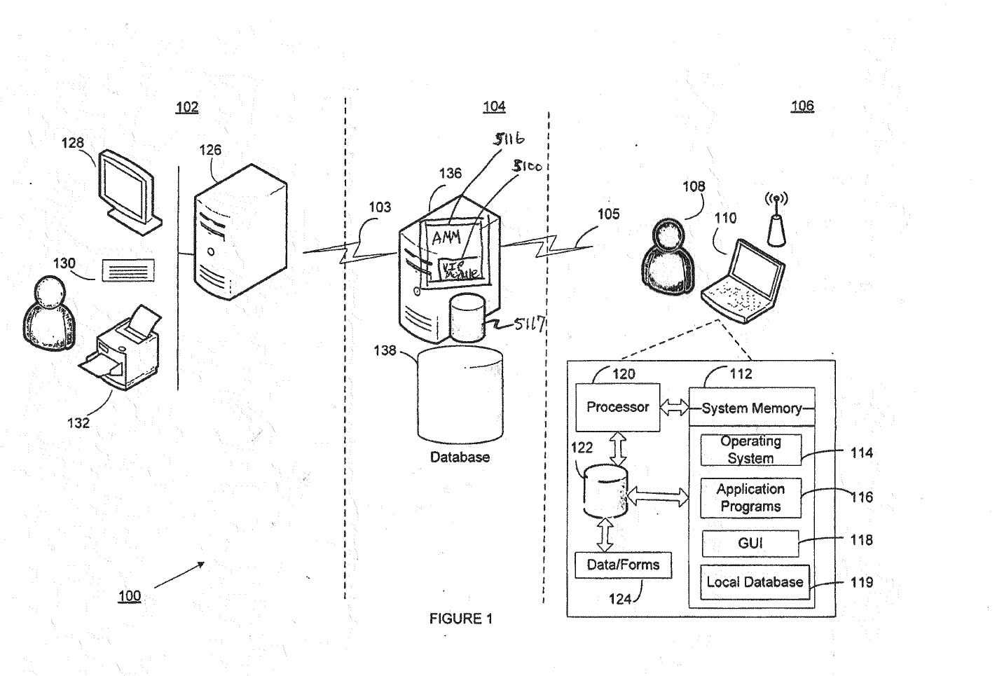

Referring to FIG. 1, a VIP module 5100 is shown in the context of an AMS 104 of the IPM application. As used herein, the terms “annuity,” “annuity fee”, “annuity payment”, “renewal”, “maintenance”, “maintenance payment,” and “maintenance fee,” and any and all forms thereof, are used interchangeably and refer to a payment due and/or made in order to preserve a piece of IP. Shown as part of the AMS 104, the VIP module 5100 may communicate with client systems 103 and 106 via communication links 102 and 105, respectively. While the VIP module may be written in a variety of computer languages, preferably, it is written in an object oriented language such as C#.

The AMS 104 is comprised of a processor (included in the box denoted by reference numeral 136), a memory 5117, and a program which is referred to as an Annuity Management Module (“AMM”) 5116. The processor may, but does not have to, include, e.g., processor 120. The processor may be an Intel x86 multiprocessor running in a Windows® environment. Further, the memory 5117 may, but does not have to, include, e.g., system memory 112. Finally, both the AMM 5116 and the VIP module 5100 may, but do not have to, include, e.g., functionality from application programs 116. The processor may be a part of a server or set of servers such as a database server, a web server, and an application server. The AMM 5116 preferably includes components such as security, GUI presentation, data intake, data management, rules processing, and instruction processing. Data storage may be done in a commercially available database environment such as SQL server.

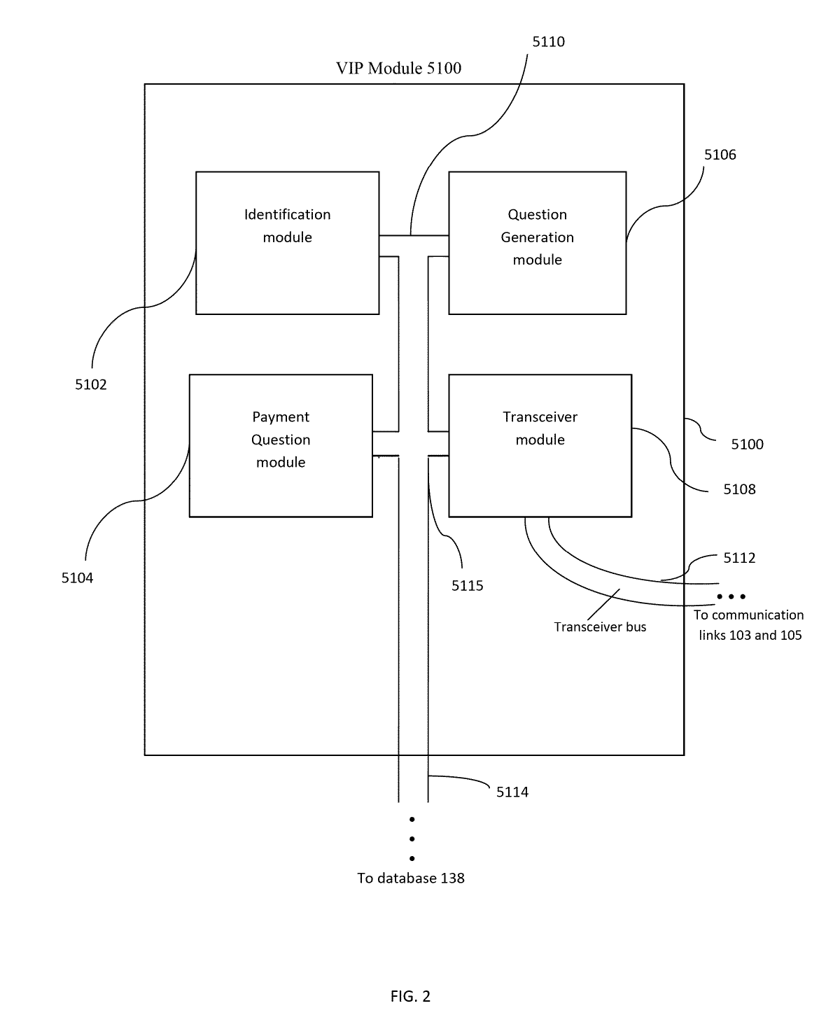

Referring to FIG. 2, the VIP module 5100 is comprised of an identification module 5102, a payment question module 5104, a question generation module 5106, and a transceiver module 5108. Communications bus 5110 serves to interconnect the identification module 5102, the payment question module 5104, the question generation module 5106, and the transceiver module 5108. The communications bus 5110 is also connected to a bus 5114 at point 5115. The transceiver module 5108 is communicably coupled, though not necessarily directly connected, to communication links 103 and 105 via transceiver bus 5112. Further, the VIP module 5100 is communicably coupled, though not necessarily directly connected, to database 138 via bus 5114. Preferably, the VIP module 5100 is part of AMM 5116. The database 138 is used to manipulate data stored in memory 5117 as will be discussed herein.

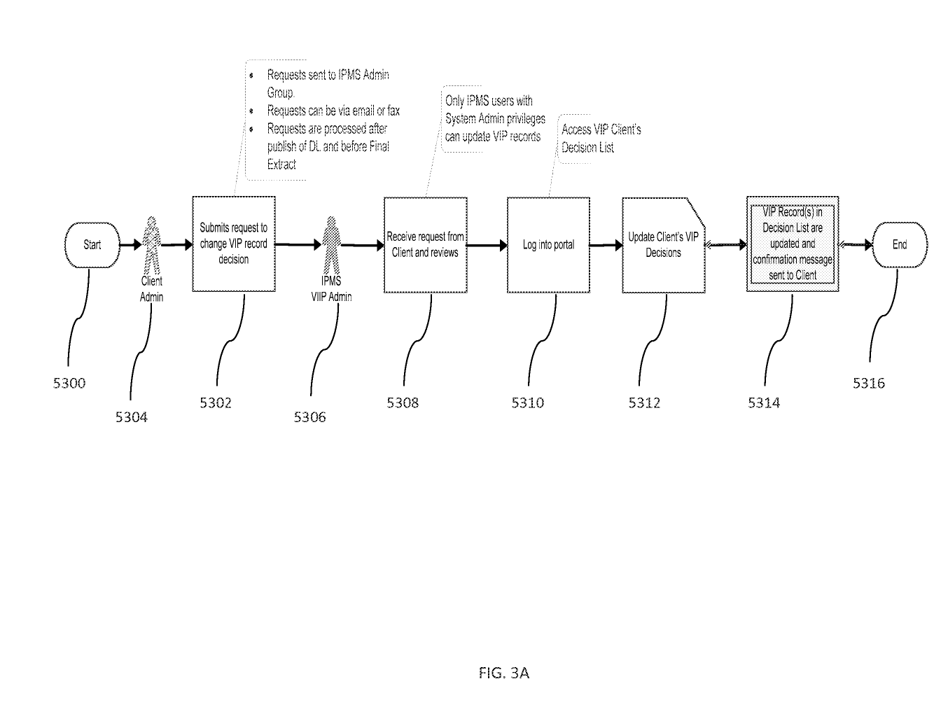

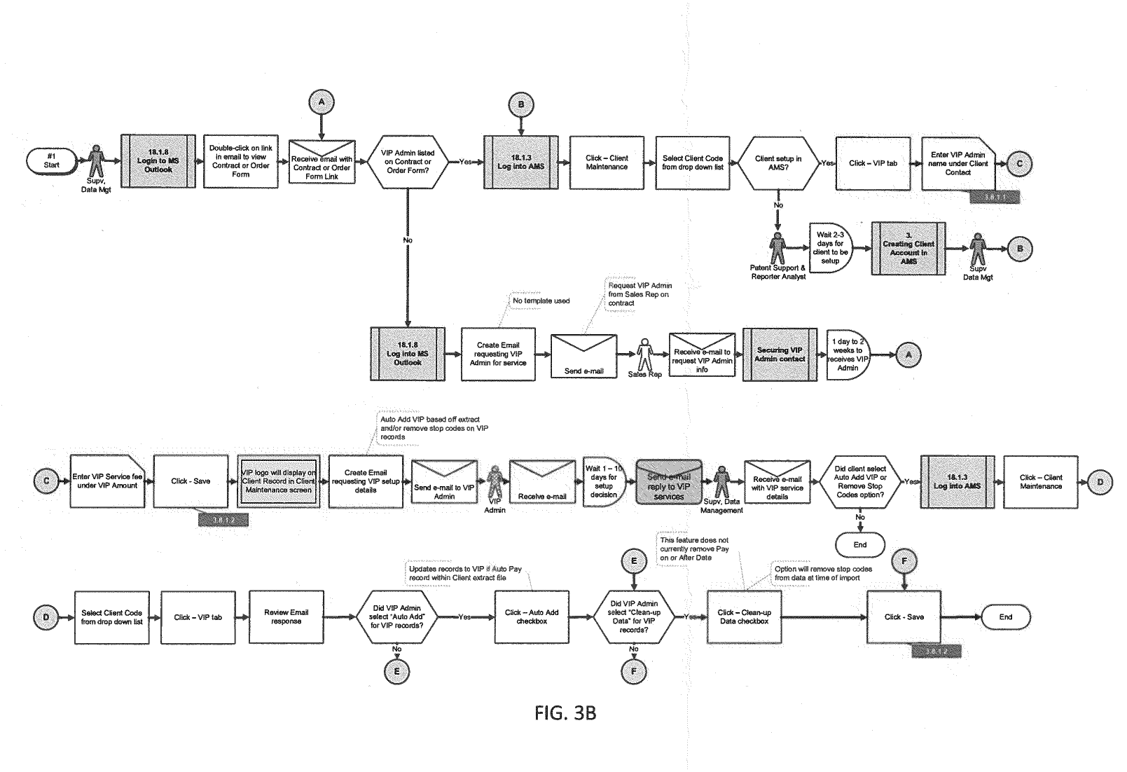

FIG. 3A shows how a particular piece of IP is designated as a VIP piece of IP. More specifically, the process begins with box 5300 and box 5302. A client 5304 sends a request to an IP payment services provider 5306 such as Thomson IP Management Services. The request should state that, for the particular piece of IP being designated as a VIP piece of IP, the client always desires to maintain the particular piece of IP. Those skilled in the art realize that the designation may be for, e.g., a particular patent, patent application, trademark, trademark application, service mark, or service mark application. Further, the designation may apply to one or more countries. The request may be sent by, e.g., email, fax, postal mail, or other methods. Preferably, the request should be in writing and should be from an authorized agent of the client. This could also be done through a web portal or an electronic cloud if systems such as Connected IP Payments and Thomson IP Manager® communicate directly with each other. Next, as shown in box 5308, the IP payment services provider 5306 reviews the request. This review entails checking to see if the particular client owns this piece IP and ensuring that all information required to calculate future payment details and effect payments is present and correct. Next, as shown in box 5310, an employee of the IP payment services provider 5306 logs into the client/server communication system 100 (“system 100”). Next, the employee, having privileges to update VIP records, updates the record for the piece of IP, designating it as a VIP piece of IP. This step is shown in box 5312. Finally, as shown in box 5314, prior to the conclusion shown in box 5316, the record for the particular piece of IP designated as a VIP piece of IP is updated and stored in memory 5117 and a confirmation message is sent to the client.

Referring again to FIG. 3A, those skilled in the art realize that multiple pieces of IP may be designated as VIP pieces of IP at the same time. For example, one may designate more than one country for a particular piece of IP and/or designate two or more pieces of unassociated IP (e.g., one patent and one trademark). The request may be specific to individual filings, or may be a more generic request (e.g. all patents assigned to a particular division, all trademarks in a specific country, etc . . . ).

Having described the process by which pieces of IP may be designated as VIP pieces of IP with respect to FIG. 3, it is useful to have background describing the process by which the IP payment services provider 5306 and the client 5304, interacting with the AMS 104 of system 100, work together to ensure authorized payments are made on behalf of the client 5304. An IP payment services provider 5306 typically handles many payments in a given time period for the client 5304. As clients report financial information on a quarterly basis, an IP payment services provider 5306 will typically have their bulk payment cycle (“BPC”) on a quarterly basis. For example, in order to have all decisions made in a timely fashion, the IP payment services provider 5306 typically requests that, in a given year, decisions from the client 5304 relating to payments due in the third quarter be finalized by the end of the first quarter. This permits the IP payment services provider 5306 at least one full quarter (e.g., the second quarter in this example) to make payments, retain agents to make payments if necessary, verify all authorized payments have been made, and report back to the client 5304. While this process will be further described with respect to a single client, those skilled in the art will appreciate that this process typically entails more than one client and different cycles for each client (e.g., client #1 may want a quarterly BPC and client #2 may want a monthly BPC).

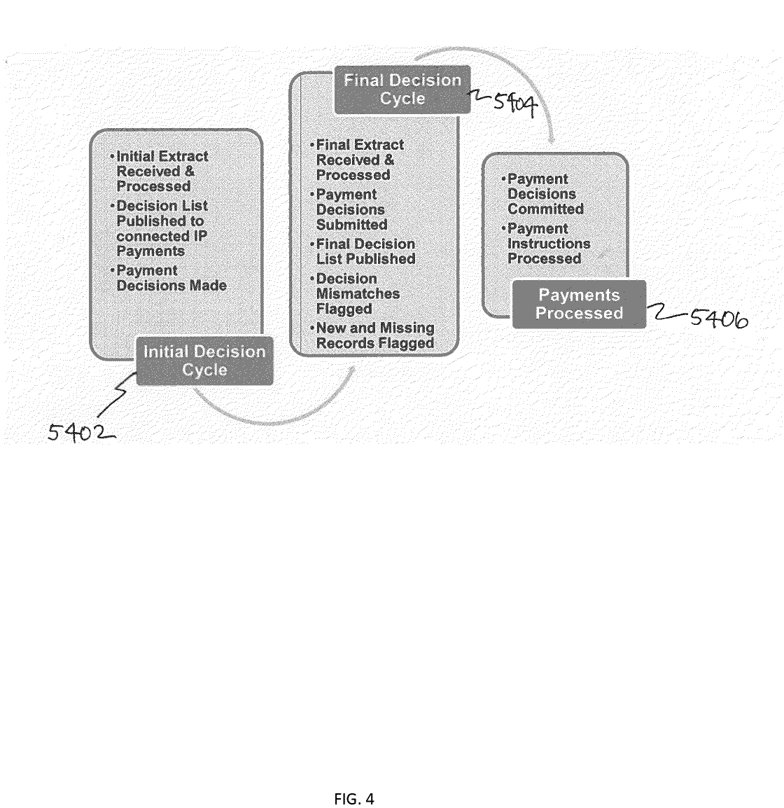

Referring to FIG. 4, a BPC is shown as having three components which are an initial decision cycle (“IDC”) 5402, a final decision cycle (“FDC”) 5404, and a decisions committed stage (“DCS”) 5406. More specifically, we will explain how, within what is called a bulk payment cycle (“BPC”), a VIP piece of IP is treated as opposed to non-VIP pieces of IP. This will be done in the context of each of the three cycles, namely the IDC 5402, the FDC 5404, and the DCS 5406.

### The Initial Decision Cycle

The IDC 5402 is used to capture payment decisions made by the client 5304. The IDC begins with receipt of an initial data exchange, also referred to as an “extract,” from the client 5304. The extract is generated by the client 5304 running an extraction program on a database such as Thomson IP Manager® (see, e.g., elements 116 and 119 of FIG. 1). The extraction program functions to create an extraction file comprising necessary information from which a set of payment questions may be derived. The resulting file is sent via email or other electronic transfer (e.g., FTP, upload from website, direct electronic transfer between client and vendor databases, etc . . . ) from the client 5304 to the IP payment services provider 5306. Files may be sent in a variety of formats, as is the case when clients using other portfolio management systems (not provided by the payment vendor) send data for payment processing. Alternatively, the system may be configured to accept automated data transfers initiated automatically by the client's portfolio management systems (e.g., Thomson IP Manager®), eliminating the need for a user to initiate the transfer. The extraction file may be stored in memory 5117 (see FIG. 1) by the IP payment services provider. Next, having received the extraction file, the AMS 104 generates an initial decision list and an initial quote for the client 5304. This initial decision list is a list of various pieces of IP for which individual payments are due in, e.g., the third quarter in order to prevent the various pieces of IP from lapsing. The initial decision list is generated by the AMS 104 automatically, using a set of IP rules, and published to the system 100 where the client 5304 may access it through the AMS 104. An example of an AMS 104 offered by Thomson Reuters may be found at http://thomsonipmanagement.com/client-resources which requires an account with a login and password. The set of IP rules relates to dates on which maintenance payments and/or annuities are due in various countries throughout the world for various pieces of IP. It also includes the amounts of these payments and provides a total amount referred to as an initial quote. The set of IP rules is updated by the IP payment services provider 5306 as needed based upon changes in, e.g., fees and due dates promulgated by various governmental IP offices throughout the world. The client 5304 is also sent an electronic communication which alerts the client 5304 that decisions for the current BPC are due and that an initial decision list has been published to the system 100. Once published, the client 5304 may make payment decisions via the AMS 104. As each payment decision is made, a running total is displayed. The initial quote, also generated from the set of IP rules, enables the client 5304 to engage in sound financial planning with respect to its IP estate as will be known and appreciated by those skilled in the art.

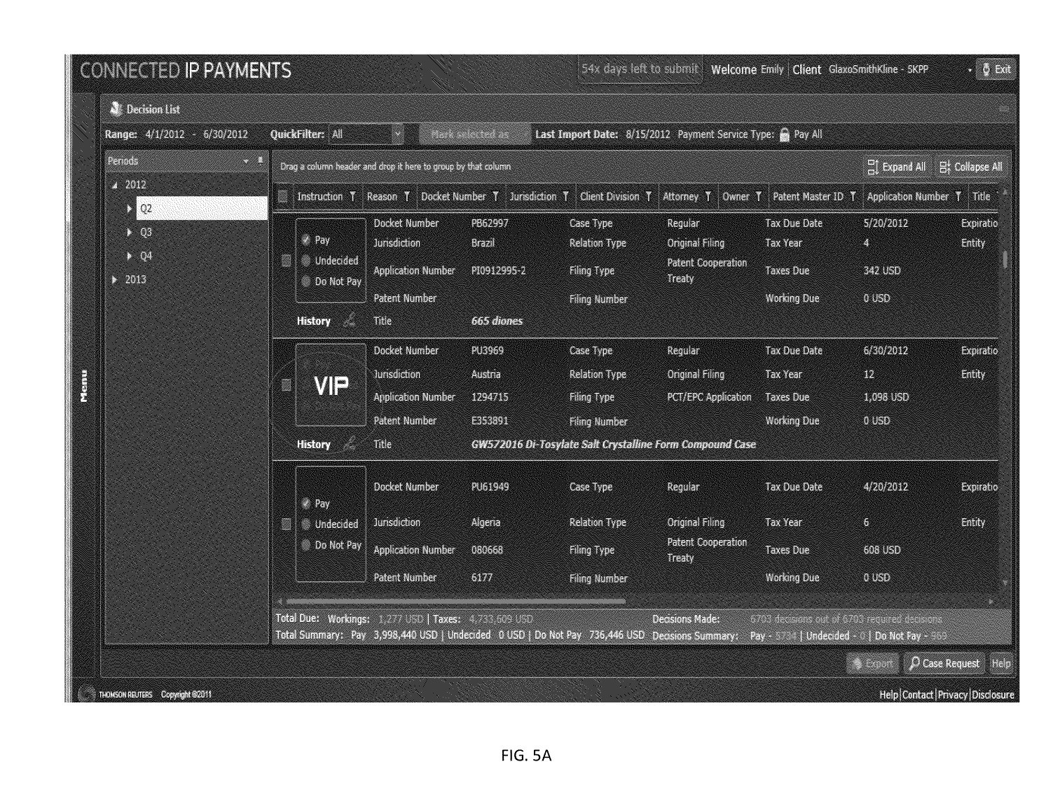

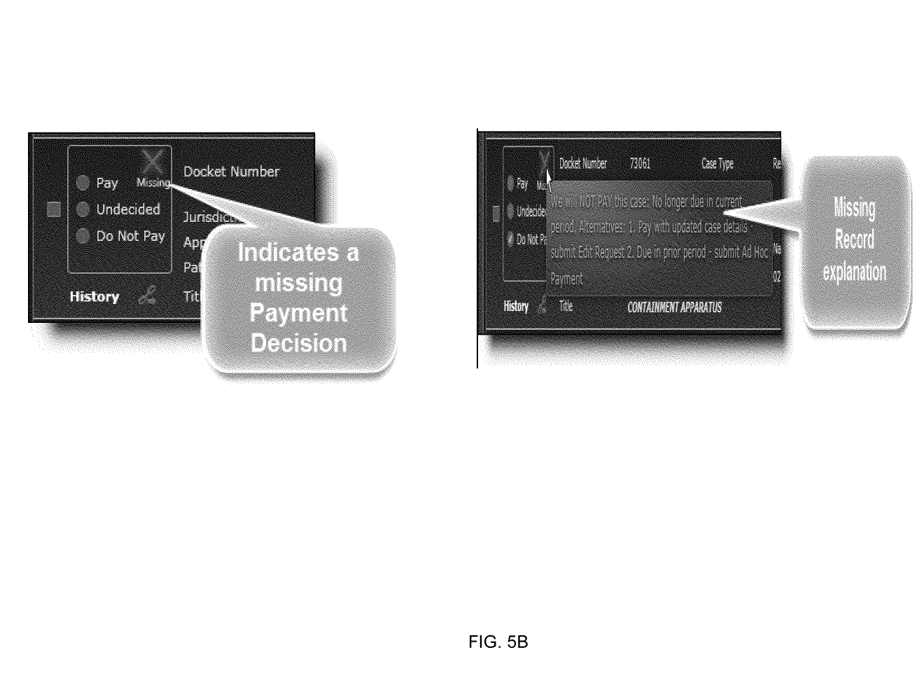

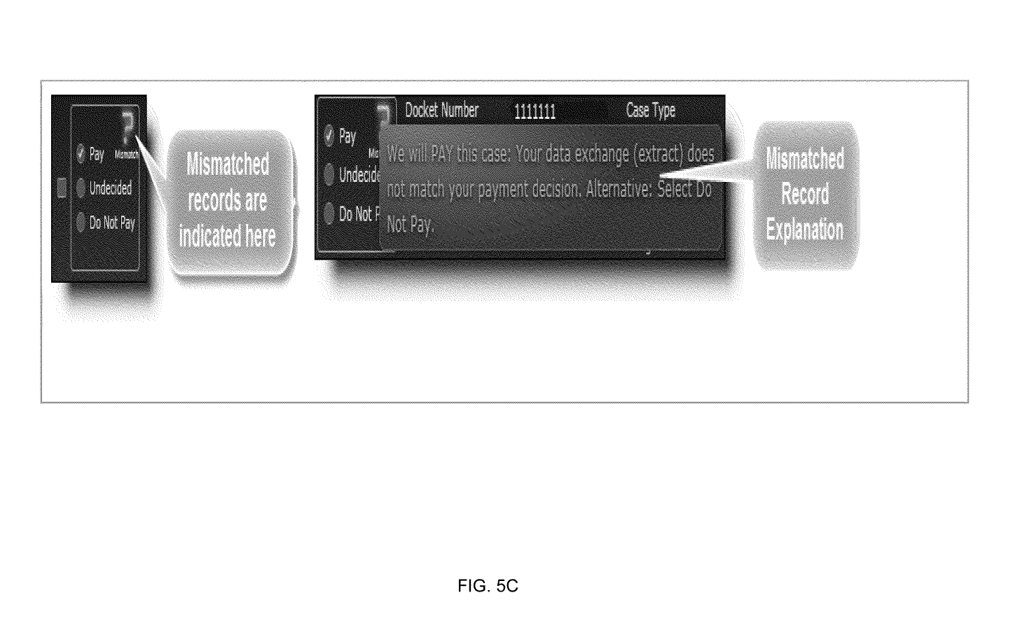

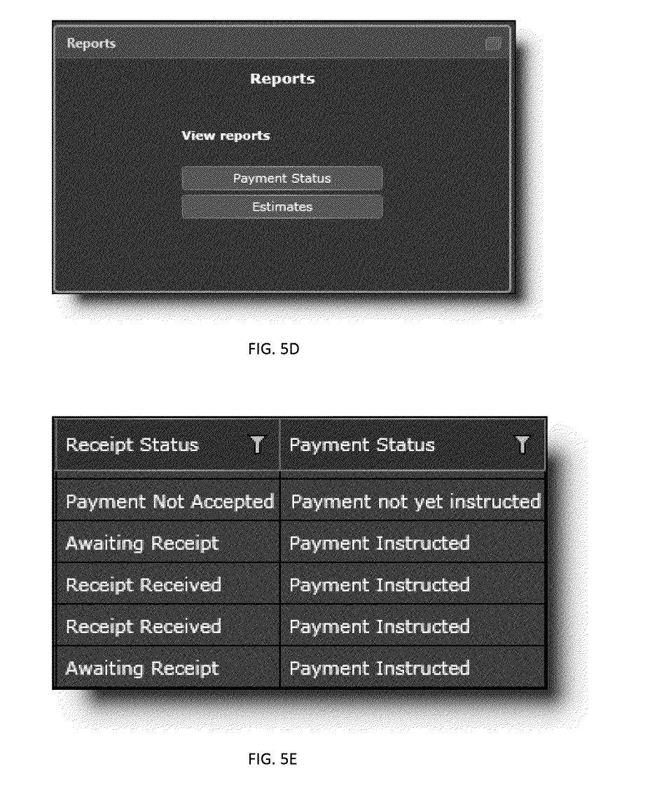

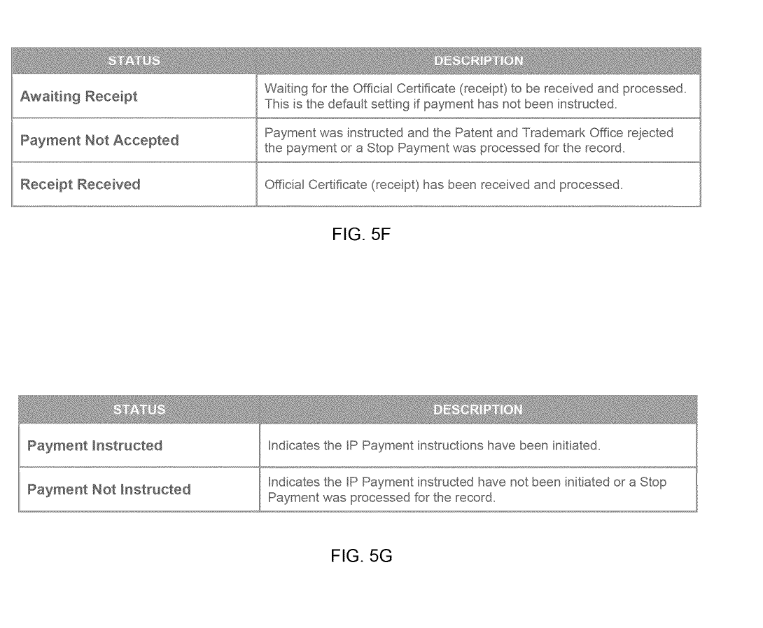

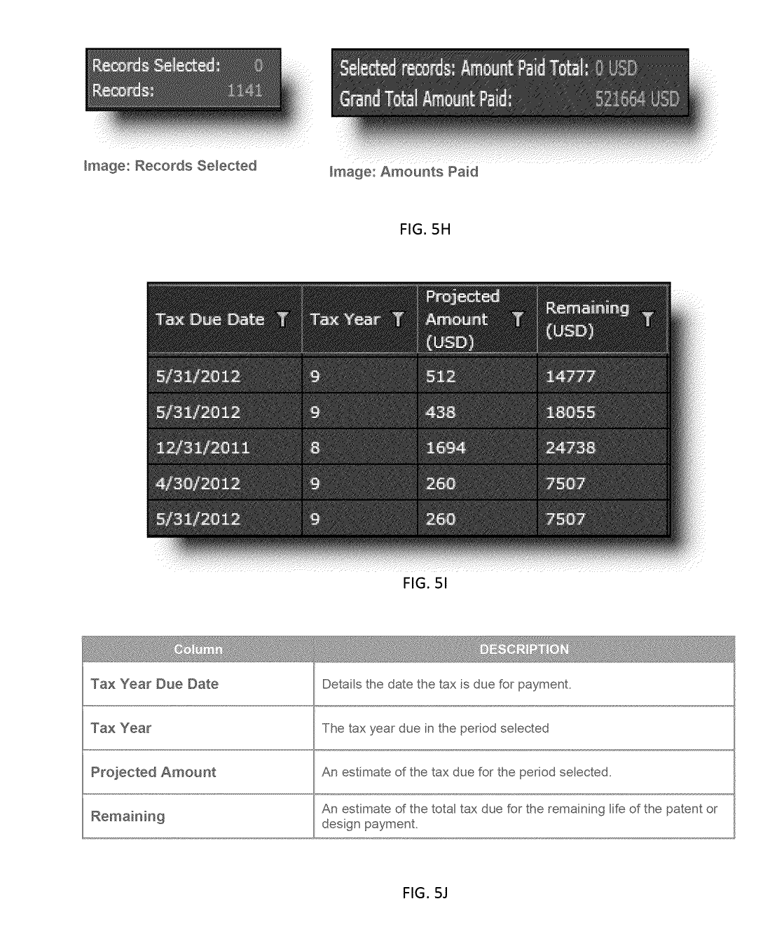

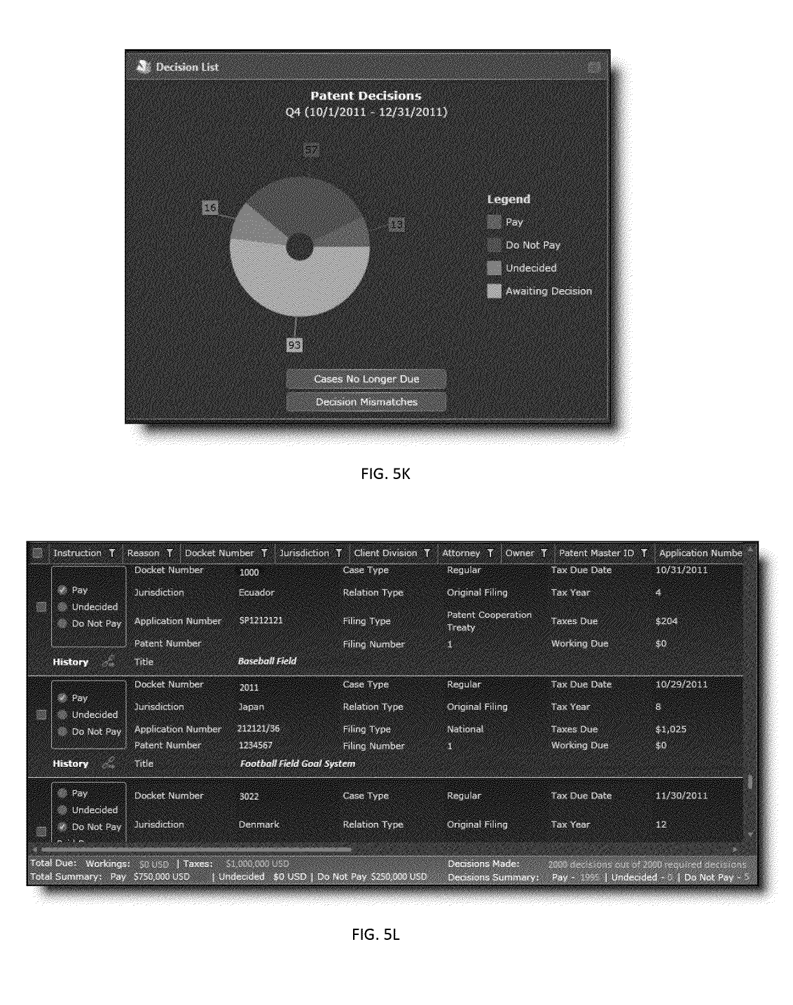

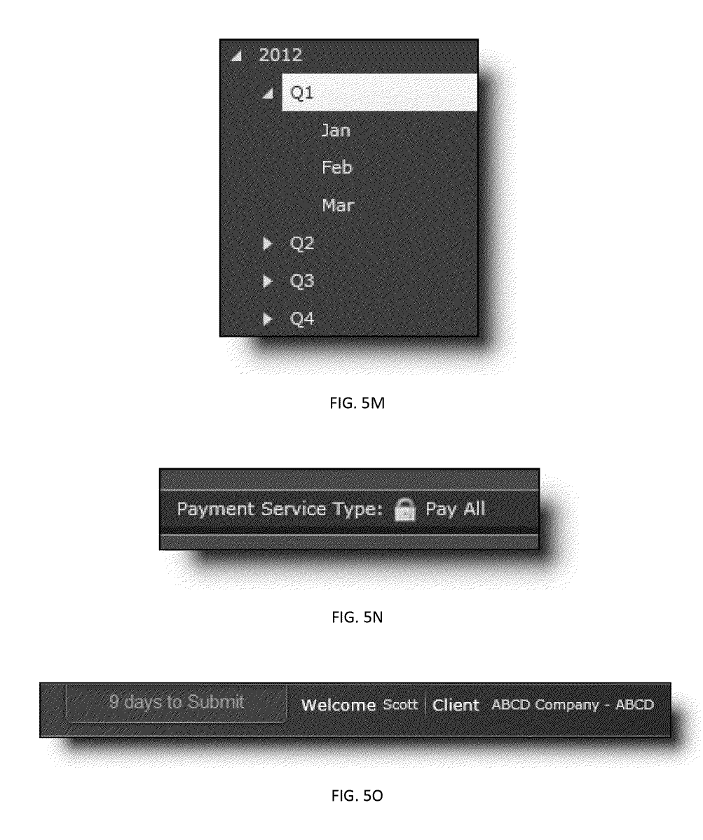

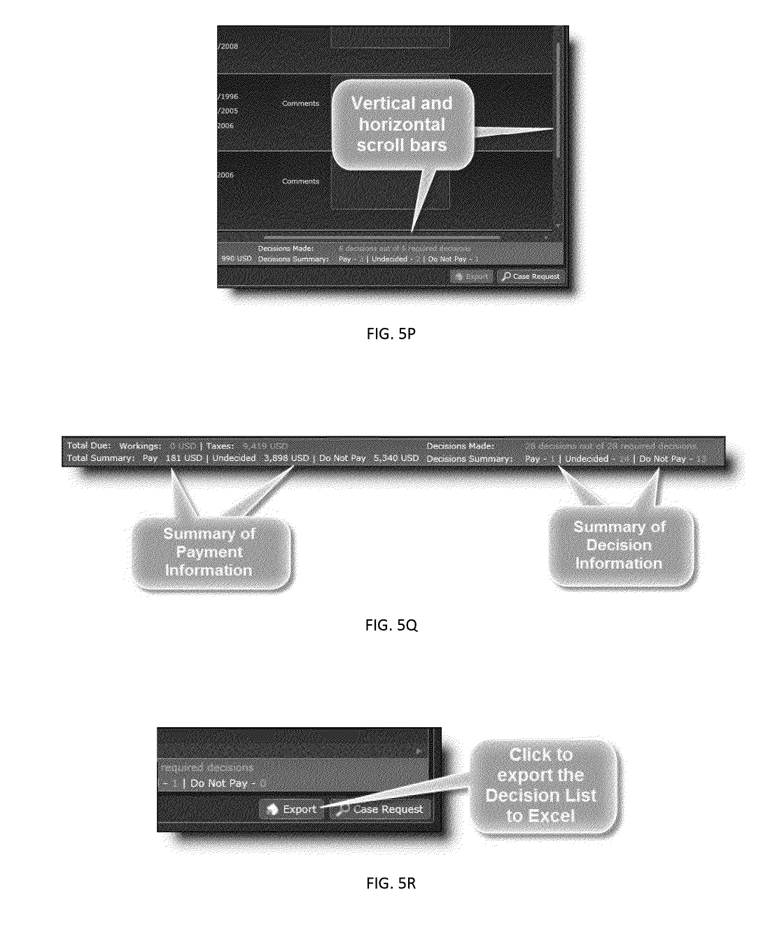

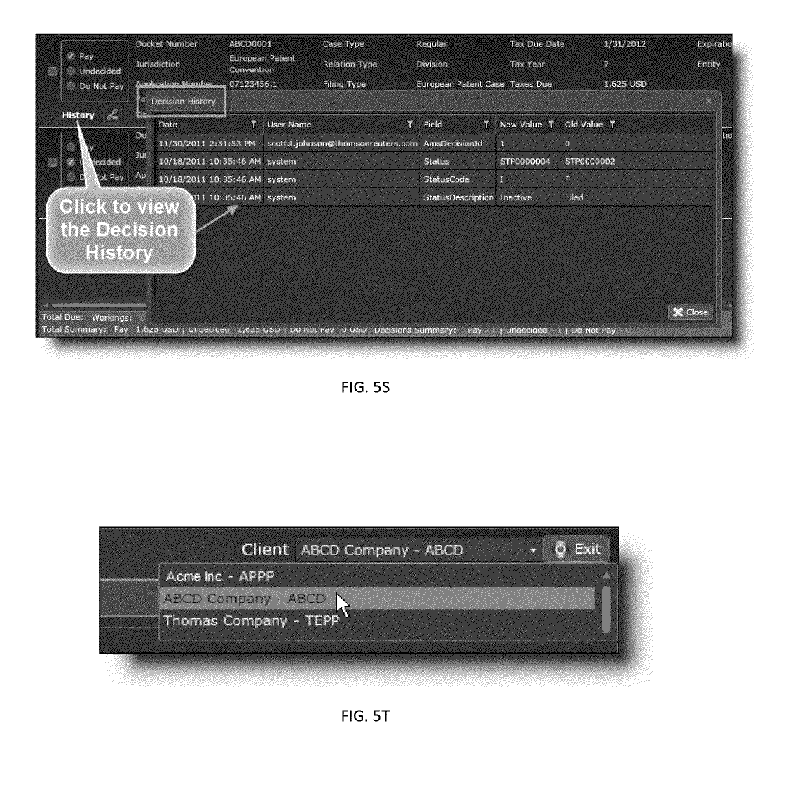

A client 5304 of the system 100 may be a “pay select” client or a “pay all” client. If the client 5304 is a “pay select” client, “Do Not Pay” records in the extraction file shall be so designated in the initial decision list available to the client 5304 of the system 100. If a piece of IP is designated as a VIP piece of IP, it shall be reflected in the initial decision list. Finally, if a piece of IP is designated as neither a VIP piece of IP or a “Do Not Pay” piece of IP, the decision options in the initial decision list will be blank and require a decision from the client 5304. Exemplary screen shots and user interfaces associated with “Do Not Pay,” VIP, other pieces of IP, and other features are shown and described with respect to FIGS. 5a through St. For example, a piece of IP bearing a VIP designation will be designated as shown in the red circle of FIG. 5a. The VIP designation sets the specific record to “Pay” by default and may only be changed by written instruction from an authorized representative of the client 5304, after verification by the IP payment services provider 5306. the client 5304. Even if a VIP record is inadvertently selected as a “Do Not Pay” record during the IDC 5402 via the client 5304 using the AMS 104, it will be overridden by an automated algorithm that prevents storage of both a VIP and a “do not pay” instruction. VIP data is stored with the case record, and is marked at a client level. For a client 5304 needing to make a decision during the BPC, the initial decision list shows the client 5304 the number of days until “Submit Day” which is the day on which the IDC 5402 ends. By way of example, in FIG. 5a it is 54 days. The “Submit Day” is the contracted date or time frame upon which payment decisions are due. For example, a client 5304 may have agreed to submit decisions by March 31 of each year for those payments due in the third quarter of a given year.

In order to authorize payments during a BPC, a “pay select” client must first reach a screen similar to FIG. 5a. To do this, the client 5304 logs into the AMS 104. Next, the appropriate account is selected from those the client 5304 is allowed to access. At this point, the client 5304 should see a screen similar in functionality to the screen shown in FIG. 5a. Next, the decision list window is expanded. At this point, the client 5304 selects the appropriate period(s) for the record(s) for which payment decisions will be made. After this, the client 5304 locates the specific record for which a payment decision will be made. Next, for this specific record, the client 5304 checks one of three boxes, namely “Pay”, “Undecided”, or “Do Not Pay.” At this point, the payment and decision bar, shown and discussed more fully with respect to FIG. 5q below, is automatically updated. The AMS 104, and particularly the functionality associated with FIG. 5a, permits the client 5304 to add comments, if desired, supporting and/or explaining the decision for the given record. This is important during a change or transition of responsibilities so that a new person receives the benefit of the reasoning of their predecessor. Finally, the client 5304 accesses a different record and repeats the process for each record requiring a decision. Those skilled in the art realize that the AMS 104 may permit the client 5304 to engage in a process by which decisions are made in bulk. For example, a client 5304 may select a number of records and then, with a single click, have the same decision (e.g., “pay”) applied to all selected records.

### The Final Decision Cycle

The FDC 5404 begins after the “Submit Day” and continues through the “Commit Date.” A number of tasks are performed during the FDC 5404. First, as explained with respect to the IDC 5402, the extraction program is used to create a final extraction file. The resulting file is sent via email or other techniques discussed above from the client 5304 to the IP payment services provider 5306. The final extraction file may be stored in database 138 (see FIG. 1). At this point during the FDC 5404, records are updated and a revised set of IP rules may be applied. As with the IDC 5402, during the FDC 5404, the client 5304 is sent another electronic communication which alerts the client 5304 that decisions for the current BPC are due and that a final decision list has been published to the system 100. Once published, the client 5304 may make payment decisions. The final decision list will contain newly added pieces of IP in addition to showing pieces of IP for which a decision has already been made during the IDC 5402. For those pieces of IP for which no decision was made during the IDC 5402, the final decision list will designate these records as needing a decision as shown in FIG. 5b. As with the IDC 5402, during the FDC 5404, a piece of IP bearing a VIP designation will be designated as shown in FIG. 5a. Again, as in the IDC 5402, the VIP designation sets the specific record to “Pay” by default and may only be changed by written instruction from an authorized representative of the client 5304. Also, even if a VIP record is inadvertently selected as a “Do Not Pay” record during the IDC 5402 via the client 5304 using the AMS 104, it will be overridden as explained with respect to the IDC 5402.

During the FDC 5404, a number of other tasks are performed. For example, during the FDC 5404 missing records are flagged for client 5304 review. A missing record is a record for which a payment decision of “Pay” was made on, e.g., the initial decision list via the AMS 104 wherein, due to a change in the IP rules, a decision is no longer due for the current period. As shown in FIG. 5b, hovering the mouse over the missing record icon displays an explanation of alternatives to the client 5304 logged into the AMS 104 during the FDC 5404. Another example is that new records are appended to the final decision list. Also, mismatched records are identified with a question mark for the attention of the client 5304 as shown in FIG. 5c. A mismatched record is a record for which a payment decision made during the IDC 5402 (e.g., “Pay”) is different from a payment decision made during the FDC 5404 (e.g., “Do Not Pay”). The AMS 104 tracks this and alerts the client as to these changes and/or potential discrepancies. As with FIG. 5b relating to records for which no decision has been made, scrolling over the mismatched designation (e.g., the question mark of FIG. 5c) provides the client 5304 with an explanation as to how the record will be handled and various options for the client 5304.

### The Decisions Committed Stage

During the DCS 5406, the client 5304 receives a communication indicating that changes have been made to the decision list for the current BPC. This ensures that the records of both the client 5304 and IP payment services provider 5306 reflect the desires of the client. At this point, the IP payment services provider 5306 begins the process of effectuating payments on pieces of IP as instructed by the client 5304. This may be done by the IP payment services provider 5306 directly and/or through agents. The interactive decision-making features of the AMS 104 are disabled for certain cases and must be handled via an ad hoc process and system described in within this payment cycle, such that any subsequent changes must be handled through the ad-hoc request process as described in the Ad Hoc application.

After completion of the DCS 5406 portion of the BPC, the client 5304 may want to retrieve records associated with the BPC. All such records are electronic backup documents. For example, the client 5304 may need to get a payment receipt. The AMS 104 helps by permitting the IP payment services provider 5306 to upload, e.g., receipts for access by the client. The receipts may be stored in memory 5117. Also stored in memory 5117 are, e.g., documents the AMS 104 may use to generate the various decision lists (e.g., the set of payment questions) for the client 5304. Such documents may comprise some or all of the publicly available records regarding pending and issued pieces of IP. These documents comprise important information such as filing dates and priority dates. Depending upon the relationship between the client 5304 and the IP payment services provider 5306, these documents may also comprise non-public documents. Like the receipts, these documents may also be stored in memory 5117. Database 138 and the rest of the AMS 104 may be used, in conjunction with memory 5117 to accomplish record retrieval.

Having described the BPC comprising the IDC 5402, the FDC 5404, and the DCS, it is instructive to describe how a client 5304 may interact with the AMS 104. FIG. 5d allows a client 5304 to review the current status of instructions to an IP payment services provider 5306, along with any other reports the client 5304 may request from time to time (e.g. special analysis of payments due, summary of fees by business unit or responsible party, etc . . . ) which are generated by the IP payment services provider 5306.

Activating the Payment Status button of FIG. 5d opens a Reports screen from which queries may be run. This results in populating the screen of the AMS 104 with records matching the search parameters of the client 5304. As shown in FIG. 5e, the Receipt Status and Payment Status columns show the payment status of a particular record. The Receipt Status has one of three values, namely, Awaiting Receipt, Payment Not Yet Accepted, and Receipt Received. These values, along with their descriptions, are shown in FIG. 5f. The Payment Status has one of two values, namely Payment Instructed and Payment Not Instructed, the descriptors of which are shown in FIG. 5g. There is also an Amount Paid column which provides the information shown in FIG. 5h.

Activating the Estimates button of FIG. 5d allows the client 5304 to view projections based upon a selected time period. The client 5304 may run a query, e.g., on a particular record or set of records, resulting in the information shown in FIG. 5i. The column headings for this estimated information may include Tax Due Date, Tax Year, Projected Amount, and Remaining The descriptions for each of these columns are shown in FIG. 5j.

A client 5304 may also interact with the AMS 104 by, e.g., accessing the decision list. FIG. 5k shows a summary of the current payment decisions in the form of a pie graph. Clicking on the icon in the upper right hand corner of FIG. 5k expands the decision list, displaying information regarding individual records as shown by way of example in FIG. 5l. Some functions available through buttons on FIGS. 5k and 5l include the ability the select a payment period, the ability to determine the payment service type, and the ability to determine the number of days remaining until the submit and/or commit date as shown in FIGS. 5m, 5n, and 5o, respectively. Access to these functions is also available through the interface shown in FIG. 5a.

FIG. 5p shows the use of both vertical and horizontal scroll bars that may be used as an additional feature of the present invention. These scroll bars enable the client 5304 to view all of the information regarding a specific piece of IP and are also shown, e.g., in FIGS. 5a and 5l.

FIG. 5q is analogous to the bottom portion of FIG. 5a and is referred to as the payment and decision bar. The payment and decision bar displays a summary of payment information and a summary of decision information. As shown in FIG. 5q, the payment information may be summarized by stating that the client 5304 logged into the AMS 104 has 28 decisions required of him/her and has decided to authorize one payment totaling $181.00, decided not to authorize thirteen payments totaling $5,340.00 and not yet decided on fourteen additional payments totaling $3,898. The payment information is displayed in the currency specified in the contract of the client 5304. In this example, the $181.00 is referred to as the “running total” because it is the amount the client 5304 has authorized thus far. As will be apparent to those skilled in the art, the running total adjusts as the client 5304 makes additional decisions. The payment and decision bar also permits the client 5304 to be informed as to how much they are “saving” by not making certain payments and conduct other planning For example, a client may be told by a supervisor that s/he may only authorize $2,000.00 of the pending $3,898 worth of decisions that still have to be made. As another example, as shown in FIG. 5a, a client 5304 of a larger scale has 6,703 decisions required of him/her and has decided to authorize 5,734 payments totaling $3,998,440.00 and decided not to authorize 969 payments totaling $736,446.00. The sum of “Workings” and “Taxes” numbers represent the total amount that the client 5304 could pay to preserve all IP. Note that this total is equal to the total of the “Pay”, “Undecided”, and “Do Not Pay” numbers. FIG. 5r shows a button which allows the client 4304 to export the decision list to a Microsoft Excel file. The export button is also shown in FIG. 5a.

FIG. 5s is an example of information shown when the client 5304 is in a decision list (see FIG. 5a) and clicks on the “history” button for a given record. The AMS 104 is used to help display the decision history for the particular record. This decision history, shown in FIG. 5s, lists changes made to the payment decisions for the record, including the date and time of the decision was made, the name of the user of the client 5304 who made the decision, and other relevant information regarding the given record.

FIG. 5t is an example of how an authorized user of the IP payment services provider 5306 may switch between accounts of various clients.

Having described how the AMS 104 may be used by a client 5304 to authorize payments, a number of other features should be noted. These are features that support the decision making and/or planning of the client.

For example, the AMS 104 may be used for analytics by, e.g., a corporate IP person desiring to know such things as: (a) the percentage of IP that is preserved (i.e., not allowed to lapse); (b) the percentage of IP that is preserved for each firm and/or each corporate IP person; (c) the percentages of (a) and/or (b) for certain time frames and/or decisions (e.g., What percentage of patent applications filed by firm X have their second maintenance fee paid in the U.S.?); (d) the percentages of applications that become patents or trademarks for a given firm or lawyer; and (e) long term budgets (e.g., how much will business unit A need to pay in the next three years to preserve all current IP); and (f) the percentages in (a), (b), (c), (d) or (e) on a country-by-country basis.

As another example, a client 5304 may decide to designate a particular piece of IP as a “pay for life” piece of IP. Only certain jurisdictions permit this. This designation may be applied only to patents and patent applications. A piece of IP designated “pay for life” shall be marked as “Do Not Pay” and be accompanied by the “paid for life” designation. This may also be done with those annuities due on a piece of IP which has been paid by another party (e.g., a co-owned piece of IP). Once designated as a “pay for life” piece of IP, the IP payment services provider 5306 may calculate the net present value of all payments due over the lifetime of the piece of IP and make, or agree to make certain payments to, e.g., an agent. This gives the client peace of mind regarding an important piece of IP. It also permits the client 5304 to make a single payment to the IP payment services provider 5306, potentially taking advantage of the fluctuations in currency. Thus, it is apparent that designating a piece of IP as “pay for life” is different from designating it as a VIP piece of IP, the latter being able to be changed whereas the former cannot be changed due to an agreement between the client 5304 and the IP payment services provider 5306 as to what the lifetime amount will be.

As yet another example, the AMS 104 may be used for forecasting and financial planning This may accomplished, as appreciated by those skilled in the art, by having the client change, e.g., a date range for a search in the AMS.

As yet another example, in both the IDC 5402 and the FDC 5404, if a client 5304 inadvertently deletes a VIP record such that it does not show up in the extraction file, the system provides another layer of protection against a piece of VIP IP lapsing if any extraction file is either void of the record or has a record that indicates it is abandoned or inactive by automatically re-activating the case in the AMM and displaying it. The case will then be processed for payment.

Finally, although the screen shots are in English, a translated “VIP” designation and other designations could be done in any language.

The embodiments described above and in the claims are intended only to illustrate and teach one or more ways of practicing or implementing the present invention, not to restrict its breadth or scope. The actual scope of the invention is defined by the appended claims and their equivalents.

What we claim is:

1. An automated computer implemented method comprising:
(a) identifying a time period;
(b) generating a set of payment questions for which at least some of a set of payment answers are due and are associated with the time period, the set of payment decisions being associated with a set of intellectual property;
(c) identifying a subset of payment questions of the set of payment questions, the subset of payment questions being associated with:
i. a subset of intellectual property of the set of intellectual property; and
ii. a subset of payment answers affirmatively indicating a desire to prevent the subset of intellectual property from lapsing;
(d) generating an electronic signal indicative of the set of payment questions, the electronic signal being characterized in that:
i. the electronic signal prohibits entry of an instruction permitting the lapsing of a piece of intellectual property from the subset of intellectual property; and
ii. the electronic signal requests a second subset of payment answers associated with a second subset of payment questions, the second subset of payment questions being associated with a second subset of intellectual property, the subset of intellectual property being mutually exclusive from the second set of intellectual property; and
(e) transmitting the electronic signal.

2. The method of claim 1 wherein the electronic signal further comprises a running total associated with the subset of answers and the second subset of answers.

3. The method of claim 1 further comprising storing the electronic signal in a memory.

4. The method of claim 3 further comprising:
(a) associating a set of electronic backup documents with the electronic signal, the set of electronic backup documents having been used to generate the set of payment questions; and
(b) storing the set of electronic backup documents in the memory.

5. The method of claim 1 wherein the time period is one month.

6. The method of claim 1 wherein the time period is one quarter.

7. The method of claim 1 wherein the time period is six months.

8. The method of claim 1 wherein the time period is one year.

9. The method of claim 1 wherein both the set of intellectual property and the subset of intellectual property comprises patents and patent applications.

10. The method of claim 1 wherein both the set of intellectual property and the subset of intellectual property comprises trademarks, service marks, trademark applications, and service mark applications.

11. The method of claim 1 wherein each piece of intellectual property in the subset of intellectual property is designated as a VIP piece of intellectual property and further wherein each piece of intellectual property in the second subset of intellectual property is neither designated as a VIP piece of intellectual property nor a pay for life piece of intellectual property.

12. The method of claim 1 wherein each piece of intellectual property in the subset of intellectual property is designated as a pay for life piece of intellectual property and further wherein each piece of intellectual property in the second subset of intellectual property is neither designated as a VIP piece of intellectual property nor a pay for life piece of intellectual property.

13. The method of claim 1 wherein each piece of intellectual property in the subset of intellectual property is designated as either a VIP piece of intellectual property or a pay for life piece of intellectual property and further wherein each piece of intellectual property in the second subset of intellectual property is neither designated as a VIP piece of intellectual property nor a pay for life piece of intellectual property.

14. An annuity management system comprising:
(a) a processor;
(b) a memory coupled to the processor; and
(c) a program stored in the memory for execution by the processor, the program configured to:
1. identify a time period;
2. generate a set of payment questions for which at least some of a set of payment answers are due and are associated with the time period, the set of payment decisions being associated with a set of intellectual property;
3. identify a subset of payment questions of the set of payment questions, the subset of payment questions being associated with:
i. a subset of intellectual property of the set of intellectual property; and
ii. a subset of payment answers affirmatively indicating a desire to prevent the subset of intellectual property from lapsing;
4. generate an electronic signal indicative of the set of payment questions, the electronic signal being characterized in that:
i. the electronic signal prohibits entry of an instruction permitting the lapsing of a piece of intellectual property from the subset of intellectual property; and
ii. the electronic signal requests a second subset of payment answers associated with a second subset of payment questions, the second subset of payment questions being associated with a second subset of intellectual property, the subset of intellectual property being mutually exclusive from the second set of intellectual property; and
5. transmit the electronic signal.

15. The annuity management system of claim 14 wherein the electronic signal further comprises a running total associated with the subset of answers and the second subset of answers.

16. The annuity management system of claim 14 the program is further configured to store the electronic signal in a memory.

17. The annuity management system of claim 16 wherein the program is further configured to:
(a) associate a set of electronic backup documents with the electronic signal, the set of electronic backup documents having been used to generate the set of payment questions; and
(b) store the set of electronic backup documents in the memory.

18. The annuity management system of claim 14 wherein the time period is one month.

19. The annuity management system of claim 14 wherein the time period is one quarter.

20. The annuity management system of claim 14 wherein the time period is six months.

21. The annuity management system of claim 14 wherein the time period is one year.

22. The annuity management system of claim 14 wherein both the set of intellectual property and the subset of intellectual property comprises patents and patent applications.

23. The annuity management system of claim 14 wherein both the set of intellectual property and the subset of intellectual property comprises trademarks, service marks, trademark applications, and service mark applications.

24. The annuity management system of claim 14 wherein each piece of intellectual property in the subset of intellectual property is designated as a VIP piece of intellectual property and further wherein each piece of intellectual property in the second subset of intellectual property is neither designated as a VIP piece of intellectual property nor a pay for life piece of intellectual property.

25. The annuity management system of claim 14 wherein each piece of intellectual property in the subset of intellectual property is designated as a pay for life piece of intellectual property and further wherein each piece of intellectual property in the second subset of intellectual property is neither designated as a VIP piece of intellectual property nor a pay for life piece of intellectual property.

26. The annuity management system of claim 14 wherein each piece of intellectual property in the subset of intellectual property is designated as either a VIP piece of intellectual property or a pay for life piece of intellectual property and further wherein each piece of intellectual property in the second subset of intellectual property is neither designated as a VIP piece of intellectual property nor a pay for life piece of intellectual property.
